(19) United States
(12) Patent Application Publication
(10) Pub. No.: US 2019/0037223 A1
(43) Pub. Date: Jan. 31, 2019

(54) Method and Apparatus of Multiple Pass Video Processing Systems

(71) Applicant: MEDIATEK INC., Hsin-Chu (TW)

(72) Inventors: Yung-Chang CHANG, Hsinchu (TW); Chia-Yun CHENG, Hsinchu (TW); Cheng-Han LI, Hsinchu (TW)

(21) Appl. No.: 16/043,348

(22) Filed: Jul. 24, 2018

Related U.S. Application Data
(60) Provisional application No. 62/536,513, filed on Jul. 25, 2017.

(51) Int. Cl. H04N 19/30; H04N 19/513

(52) U.S. Cl. CPC H04N 19/30; H04N 19/513

(57) ABSTRACT

A method and apparatus of scalable video coding using Inter prediction mode for a video coding system are disclosed, where video data being coded comprise BP (Basic Resolution Pass) pictures and UP (Upgrade Resolution Pass) pictures. In one embodiment according to the present invention, the method comprises receiving information associated with input data corresponding to a target block in a target UP picture. When the target block is Inter coded according to a current MV (motion vector) and uses a collocated BP picture as one reference picture, one or more BP MVs (motion vectors) of the collocated BP picture are scaled to generate one or more RCP (resolution change processing) MVs. The current MV of the target block is encoded or decoded using an UP MV predictor derived based on one or more temporal MVPs including said one or more RCP MVs.

### CROSS REFERENCE TO RELATED APPLICATIONS

The present invention claims priority to U.S. Provisional patent application, Ser. No. 62/536,513, filed Jul. 25, 2017. The U.S. Provisional patent application is hereby incorporated by reference in its entirety.

### FIELD OF THE INVENTION

The present invention relates to video coding. In particular, the present invention relates to multiple pass video coding that generates video streams for providing video services at various spatial-temporal resolutions and/or quality levels.

### BACKGROUND

Compressed digital video has been widely used in various applications such as video streaming over digital networks and video transmission over digital channels. Very often, a single video content may be delivered over networks with different characteristics. For example, a live sport event may be carried in a high-bandwidth streaming format over broadband networks for premium video service. In such applications, the compressed video usually preserves high resolution and high quality so that the video content is suited for high-definition devices such as an HDTV or a high resolution LCD display. The same content may also be carried through cellular data network so that the content can be watch on a portable device such as a smart phone or a network-connected portable media device. In such applications, due to the network bandwidth concerns as well as the typical low-resolution display on the smart phone or portable devices, the video content usually is compressed into lower resolution and lower bitrates. Therefore, for different network environment and for different applications, the video resolution and video quality requirements are quite different. Even for the same type of network, users may experience different available bandwidths due to different network infrastructure and network traffic condition. Therefore, a user may desire to receive the video at higher quality when the available bandwidth is high and receive a lower-quality, but smooth, video when the network congestion occurs. In another scenario, a high-end media player can handle high-resolution and high bitrate compressed video while a low-cost media player is only capable of handling low-resolution and low bitrate compressed video due to limited computational resources. Accordingly, it is desirable to construct the compressed video in a multiple pass manner so that videos at different spatial-temporal resolution and/or quality can be derived from the same compressed bitstream.

FIG. 1 illustrates an example of multiple-pass video steaming. The multiple pass video stream is capable of delivering contents in four different grades corresponding to (1) basic resolution pass (BP) at basic rate pass (BRP) 110, (2) BP at upgrade rate pass (URP) 120, (3) upgrade resolution pass (UP) 130 at BRP and (4) UP at URP 140. For example, these four grades may correspond to (1) full high-definition (FHD) at 30 fps (frames per second), (2) FHD at 60 fps, (3) ultra high-definition (MD) at 30 fps and (4) UHD at 60 fps. In FIG. 1, the arrows indicate the coding dependency among various video grades. For example, for the BP at BRP, a BP frame may use a previously coded BP frame as a reference frame. For example, BP frame 114 may use BP frame 112 as a reference frame and BP frame 116 may use BP frame 114 as a reference frame. For the BP frames at URP, a BP frame may use one or more coded BP frames at BRP as reference frames. For example, BP frame 122 at URP may use BP frames 112 and 114 at BRP as reference frames and BP frame 124 at URP may use BP frame 114 at BRP as a reference frame. For UP frames at BRP, an UP frame may use a previously coded UP frame as well as the BP frame at BRP. For example, UP frame 132 uses BP frame 112 as a reference frame, UP frame 134 uses previously coded UP frame 132 as a reference frame, and UP frame 136 uses previously coded UP frame 134 and BP frame 116 as reference frames. For the UP frames at URP, an UP frame may use one or more coded UP frames at BRP as reference frames. For example, UP frame 142 at URP may use UP frame 134 at BRP as a reference frame and UP frame 144 at URP may use UP frames 136 and 138 at BRP as reference frames.

For multiple pass with different resolutions, the BP frames have only one source in multiple pass video streaming. However, the UP frames can be multiple sources in the multiple pass video streaming. In other words, the UP source is greater than or equal to 1. For multiple pass with different frame rates, each BP or UP contains one BRP and each BP or UP may contain one or more optional URP. Syntax rate_id may be used for indicating a frame rate associated with the BP or UP, where BRP can be indicated by rate_id=0 and URP can be indicated by rate_id=1. For BP or UP, BRP with rate_id=0 can be used as reference frames of URP with rate_id=1. Furthermore, lower levels of URP (e.g. rate_id=N, N>=1) can be used as references of higher level URP (e.g. rate_id=M, M>N). For BP or UP, BRP can be combined with an upper-level URP to form a BP or UP at a higher frame rate respectively. For example, a BP or UP with rate_id=0 can be combined with a BP or UP with rate_id=1 to provide a BP or UP at a higher frame rate.

FIG. 2 illustrates an exemplary application scenario of multiple-pass video streaming. For the multiple pass video streams mentioned above, the stream can be used to provide four-grade videos with the FHD at 30 fps as the lowest grade and the MD at 60 fps as the highest grade. If users pay less, they can only view the lower resolution with lower frame rate video (e.g. FHD at 30 fps). If users pay more, they can view higher resolution and/or higher frame rate video (e.g. UHD at 30 fps or 60 fps).

FIG. 3 illustrates exemplary relation among BP pictures and UP pictures. Frame 310 corresponds to a BP frame, which is considered as source 0. An area 312 cropped (or clipped) out of BP picture 310 can be resized to a larger frame as an UP picture 320. However, cropping can be optional. In other words, the cropping area can be zero. Again, an area 322 cropped out of UP picture 320 can be resized to a larger frame as an UP picture 330. The resizing may be implemented via some re-sampling operations or post processing. In this example, the video stream contains one BP source and two UP sources.

FIG. 4 illustrates an exemplary processing architecture for generating multiple pass video outputs from a multiple pass video stream. The video stream related to the BP is provided to the BP decoder 410 to generate BP video output. The decoded BP is also processed by Resolution Change (RC) Processing unit 420 and the result may become one of the reference pictures for the UP decoding. The video stream related to the UP is provided to the UP decoder 430. If the BP picture is used as a reference picture for the UP picture, the decoded information associated the UP is combined with the reference picture generated from the BP picture using the RC Processing unit 420 to generate UP video output.

The BP decoder and the UP decoder may correspond to video decoder using Intra/Inter prediction as shown in FIG. 5. The video stream is decoded by the variable length decoder (VLD) 510 to generate symbols for prediction residuals and related coding information such as motion vector difference (MVD). The prediction residuals are processed by inverse scan (IS) 512, inverse quantization (IQ) 514 and inverse transform (IT) 516 to obtain reconstructed prediction residuals. A predictor corresponding to Intra prediction 522 or Inter prediction (i.e., motion compensation) 524 is selected by Intra/Inter selection unit 526 and the selected predictor is combined with the residuals from inverse transform 516 using adder 518 to generate reconstructed residual 528. A loop filter such as deblocking filter 530 may be used to reduce coding artifacts in the reconstructed picture. The reconstructed picture may be used as a reference picture for subsequently decoded pictures. Therefore, decoded picture buffer (DPB) 532 is used to store decoded pictures. Accordingly, a decoded picture in DPB 532 may be retrieved by Inter prediction 524 to generate an Inter predictor for an Inter-coded block.

In video coding, the motion vectors have to be signaled in the video stream so that the motion vectors can be recovered at a decoder side. In order to conserve bit rate, the motion vectors are coded predictively using a motion vector predictor (MVP). Therefore, the motion vector difference (MVD) for the current motion vector (MV) is derived according to MVD=MV−MVP. The MVD is signaled instead of the current MV. At the decoder side, the MVD is decoded from the video bitstream.

The encoder and decoder derive an MVP candidate list in the same manner so that a same MVP candidate list can be maintained at both the encoder and decoder. An index indicating the MVP selected from the MVP candidate list can be signaled in the bitstream or derived implicitly. The MVP candidate list can be derived based on spatial and temporal neighboring blocks. FIG. 6 illustrates an example of spatial and temporal neighboring blocks used to derive an MVP candidate list. As shown in FIG. 6, a current block 612 is located in the current picture 610. A collocated block 622 in the reference picture 620 is shown. Spatial MV candidates of the current block are derived from neighboring blocks A₀, A₁, B₀, B₁ and B₂, and temporal MV candidates are derived from bottom-right block T_{BR} and center-block T_{CT}.

FIG. 1 illustrates an example of coding dependence among the BP and UP pictures. A current BP picture may use previously coded BP pictures as reference pictures. An UP picture may use previously coded UP pictures as well as previously coded BP pictures as reference pictures. Therefore, MVs of the coded pictures may have to be stored for later use. FIG. 7 illustrates an example of storing MVs of n-th picture in n-th MV buffer, where n is an integer greater than or equal to 0. According to col_ref_idx and current block location, block M in Picture N will retrieve the collocated MV of block M from the MV buffer of previous picture (i.e., n=N−1, N−2, N−3, . . . ). In FIG. 7, col_ref_idx indicates the index of reference picture associated with the collocated MV.

In a conventional approach, the RCP MVs are calculated from the MVs of the BP picture and the RCP MVs for a whole UP picture are stored in a storage area. The storage requirement for the RCP MVs will cause additional cost. Also, the conventional approach processes the RCP MVs for a whole frame, stores the RCP MVs for a whole frame and retrieves the MVs for UP coding. Such approach will cause longer processing latency. It is desirable to develop methods to reduce the storage requirement and/or reduce the latency.

### BRIEF SUMMARY OF THE INVENTION

A method and apparatus of scalable video coding using Inter prediction mode for a video coding system are disclosed, where video data being coded comprise BP (Basic Resolution Pass) pictures and UP (Upgrade Resolution Pass) pictures. In one embodiment according to the present invention, the method comprises receiving information associated with input data corresponding to a target block in a target UP picture. When the target block is Inter coded according to a current MV (motion vector) and uses a collocated BP picture as one reference picture, one or more BP MVs (motion vectors) of the collocated BP picture are scaled to generate one or more RCP (resolution change processing) MVs. The current MV of the target block is encoded or decoded using an UP MV predictor derived based on one or more spatial MVPs (MV predictors), one or more temporal MVPs, or both, where said one or more temporal MVPs comprise said one or more RCP MVs.

The target block in the target UP picture may have a same frame time as the collocated BP picture. Whether the target block uses the collocated BP picture as one reference picture can be determined based on prediction mode of the target block, reference picture index of the target block, reference picture index for a collocated MV, resolution change enable flag, resolution ratio of the target UP picture and the collocated BP picture, spatial offset between the target UP picture and the collocated BP picture, or a combination thereof. The resolution change enable flag specifies whether the collocated BP picture can be referenced when decoding the target UP picture. Said one or more RCP MVs can be derived by scaling said one or more BP MVs of the collocated BP picture according to resolution ratio of the target UP picture and the collocated BP picture and spatial offset between the target UP picture and the collocated BP picture. An MVD (MV difference) between the current MV of the target block and the UP MV predictor can be signaled at an encoder side or the current MV of the target block can be reconstructed from the MVD received and the UP MV predictor.

In one embodiment, said one or more temporal MVPs may comprise one or more UP MVPs derived from one or more previous UP pictures. UP MVs from said one or more previous UP pictures and BP MVs of the collocated BP picture can be stored in a neighboring MV storage or a combination of a line storage and the neighboring MV storage. The method may comprise generating one or more addresses for the neighboring MV storage or the combination of the line storage and the neighboring MV storage according to a current location of the target block to access neighboring MV data for deriving said one or more temporal MVPs. The line storage may store at least one block row of BP MVs of the collocated BP picture. When a target UP picture uses the collocated BP picture as one reference picture, the line storage is updated.

### BRIEF DESCRIPTION OF THE DRAWINGS

FIG. 1 illustrates an example of multiple pas video steaming, where the multiple-pass video stream is capable of delivering contents in four different grades.

FIG. 2 illustrates an exemplary application scenario of multiple-pass video streaming.

FIG. 3 illustrates exemplary relation among BP pictures and UP pictures.

FIG. 4 illustrates an exemplary processing architecture for generating multiple pass video outputs from a multiple pass video stream.

FIG. 5 illustrates an exemplary processing architecture for a multiple-pass decoder, where the BP decoder and the UP decoder correspond to video decoder using Intra/Inter prediction.

FIG. 6 illustrates an example of spatial and temporal neighboring blocks used to derive an MVP candidate list.

FIG. 7 illustrates an example of storing MVs of n-th picture in n-th MV buffer, where n is an integer greater than or equal to 0.

FIG. 8 illustrates an example of collocated MV handling by the RCP (resolution change processing) for an off-line method, where memory is used to store three types of MVs corresponding to BP MVs, UP MVs and RCP MVs.

FIG. 9A illustrates another perspective of collocated MV handling by the RCP for an off-line method, where a series of UP pictures, BP pictures, UP MV buffers and BP MV buffers are indicated.

FIG. 9B illustrates an example of MVs associated with BP pictures, UP pictures and RCP stored in memory.

FIG. 10 illustrates an example of a Decode Block of RCP MV that may be scaled from four Decode_blocks of the MVs of BP picture as shown in FIG. 10.

FIG. 11A illustrates another perspective of collocated MV handling by the RCP for an on-the-fly method.

FIG. 11B illustrates an example of MVs associated with BP pictures and UP pictures for an on-the-fly method.

FIG. 12 illustrates an exemplary architecture of RCP MV derivation.

FIG. 13 illustrates an exemplary flowchart of MV derivation according to an embodiment of the present invention.

FIG. 14 illustrates another exemplary architecture of RCP MV derivation.

FIG. 15 illustrates an example that the Line Storage and Collocated MV Derivation unit being maintained regardless whether the collocated MV of UP picture is from BP or UP when resolution_change_enabled is equal to 1.

FIG. 16 illustrates an exemplary flowchart of MV derivation according to an embodiment of on-the-fly method.

FIGS. 17A-17D illustrate an example of collated MV RC processing based on the on-the-fly method.

FIG. 18 illustrates an exemplary flowchart of scalable video coding using Inter prediction mode for a video coding system incorporating an embodiment of the present invention, where video data being coded comprise BP (Basic Resolution Pass) pictures and UP (Upgrade Resolution Pass) pictures.

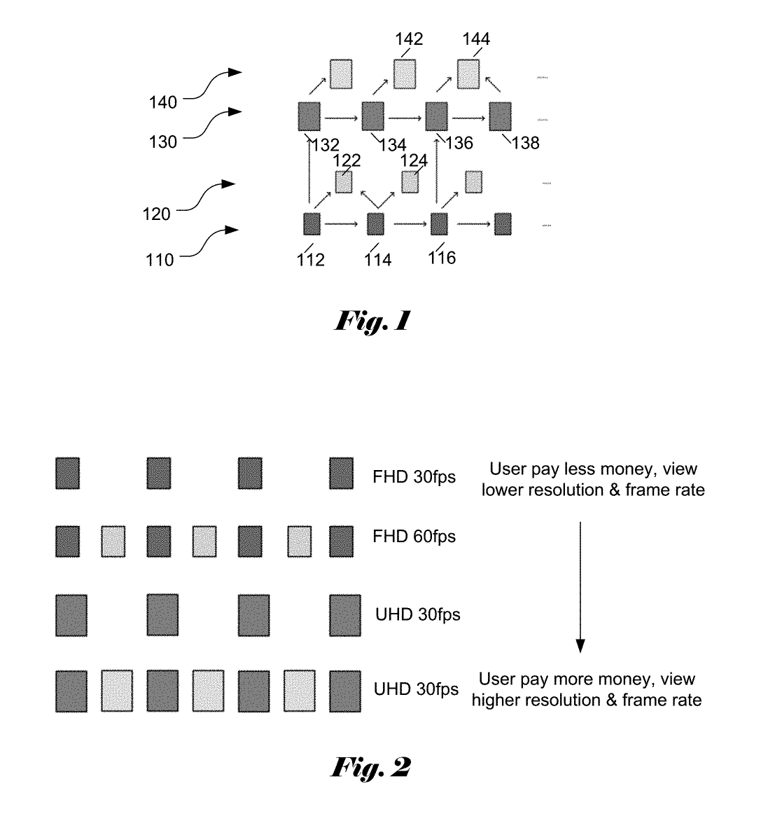

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

In the multiple pass video coding systems, the resolution change processing (RCP) will derive an UP reference picture from a coded BP picture or a lower-level coded UP picture. The RCP will utilize the motion information of the BP picture to derive the UP reference picture for encoding or decoding a current UP picture. A memory can be used to store MVs associated with BP pictures, UP pictures and the RCP. FIG. 8 illustrates an example of collocated MV handling by the RCP for an off-line method. Memory 810 is used to store three types of MVs corresponding to BP MVs, UP MVs and RCP MVs. In the example shown in FIG. 8, designated storage areas are used to store three different types of MVs. The memory operations are illustrated for different time slots. At “Time 0”, the BP picture 0 is decoded and the collocated MVs of BP picture 0 are stored in MV buffer of BP picture 0 (pic0). At “Time 1”, the MVs of BP picture 0 are scaled by RC Processing (RCP) and stored in the MV buffer of RCP pic0. At “Time 2”, the UP picture 0 is decoded at “Time 2” and the collocated MVs of UP picture 0 are stored in MV buffer of UP pic0. The UP picture 0 can access the MV buffer of RCP pic0 to get collocated MV when the reference picture is BP picture 0. The collocated MV RCP off-line method needs storage of RCP MV buffer to store the RCP MVs scaled from the MVs of BP picture. The memory operations continue for the next picture (i.e., picture 1) as shown in FIG. 8.

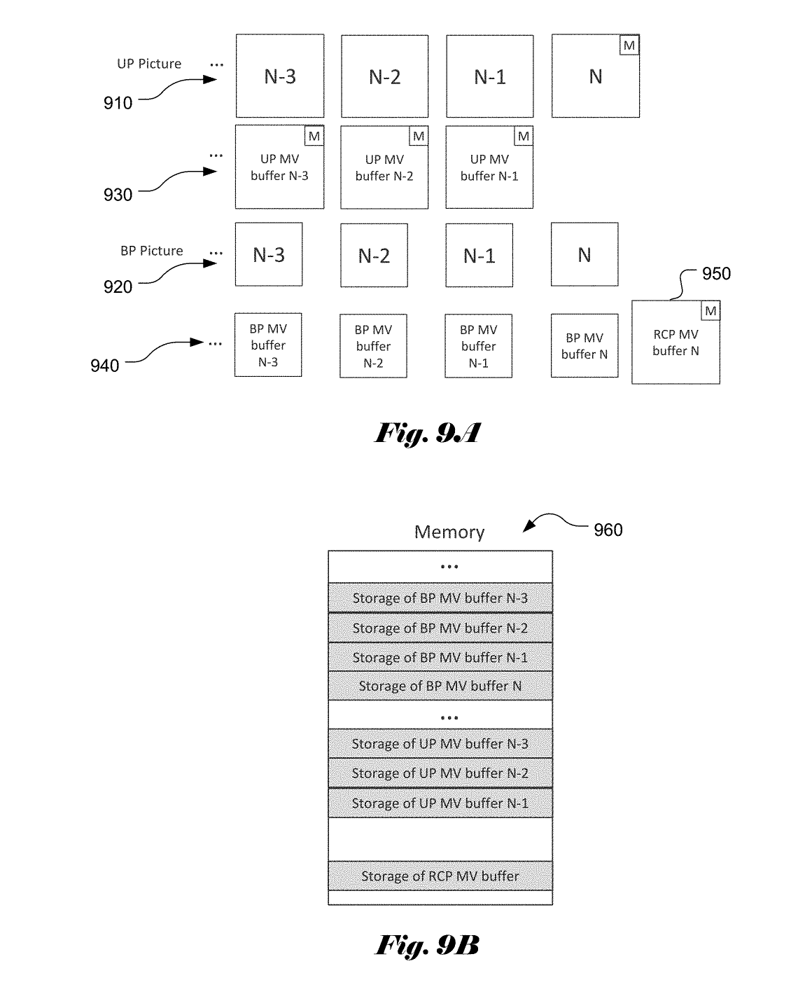

FIG. 9A illustrates another perspective of collocated MV handling by the RCP for an off-line method, where a series of UP pictures 910, BP pictures 920, UP MV buffers 930 and BP MV buffers 940 are indicated. Also, RCP MV buffer N 950 is shown in FIG. 9A. The MVs of n-th UP picture or BP picture will be stored in n-th UP MV buffer or BP MV buffer respectively, where n is an integer starting from 0. The RCP MVs scaled from the MVs of n-th BP picture will be stored in “Storage of RCP MV buffer”. According to col_ref_idx and current block location, block M in UP Picture N will get the collocated MV of block M from the RCP MV buffer or the UP MV buffer of previous picture with picture index N−1, N−2, N−3, etc. FIG. 9B illustrates an example of MVs associated with BP pictures, UP pictures and RCP stored in memory 960.

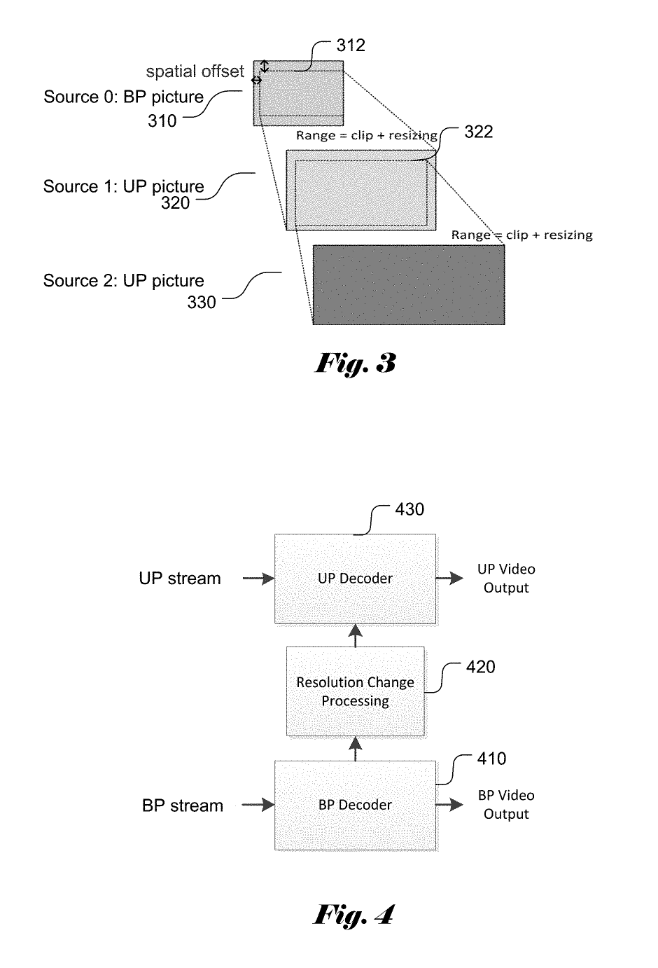

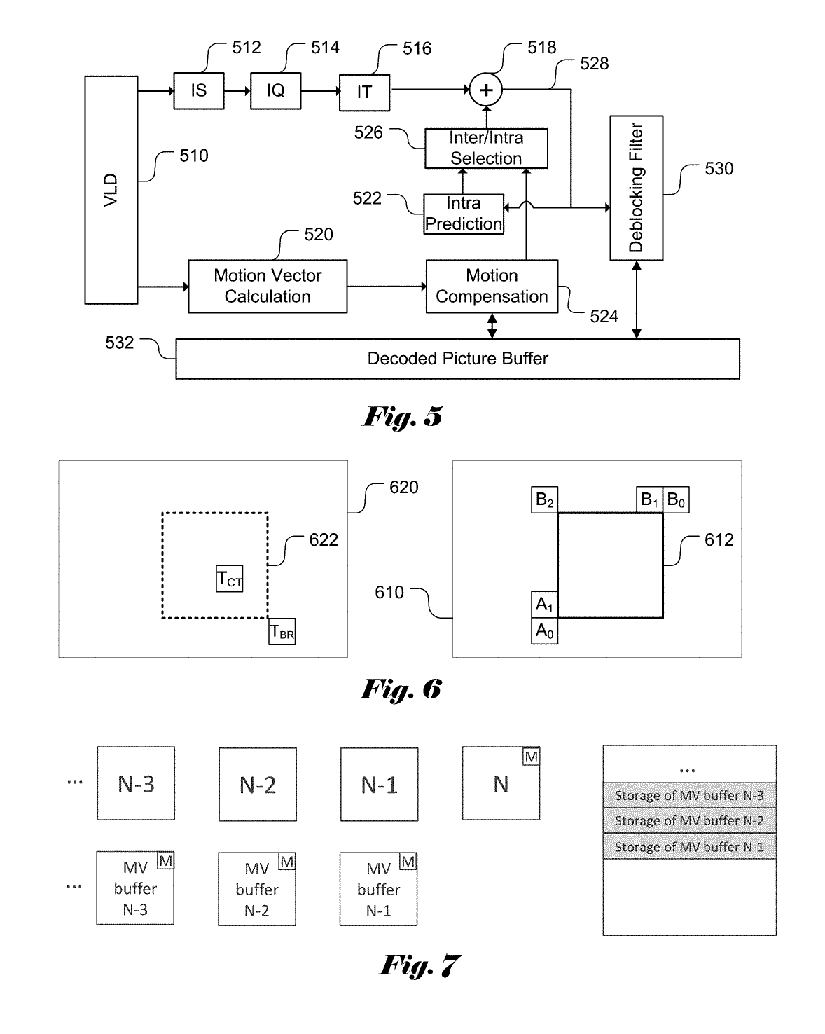

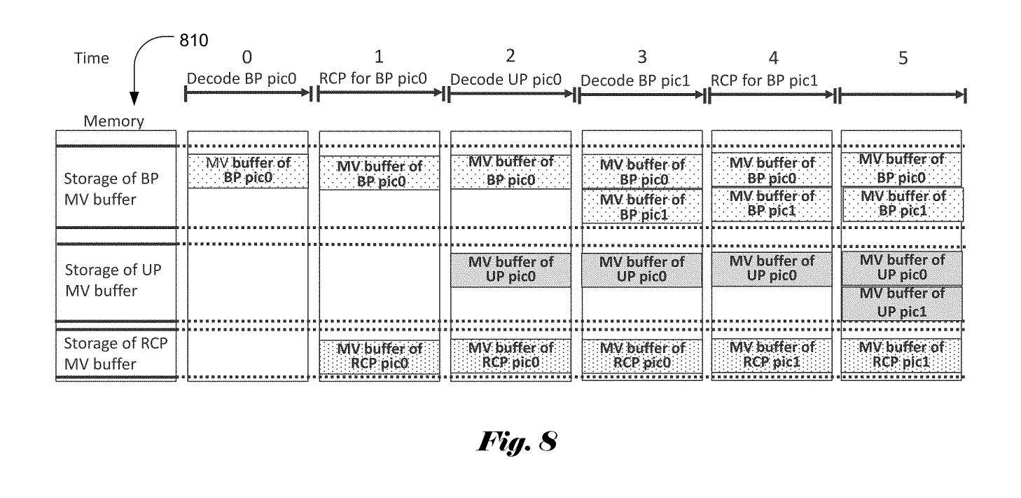

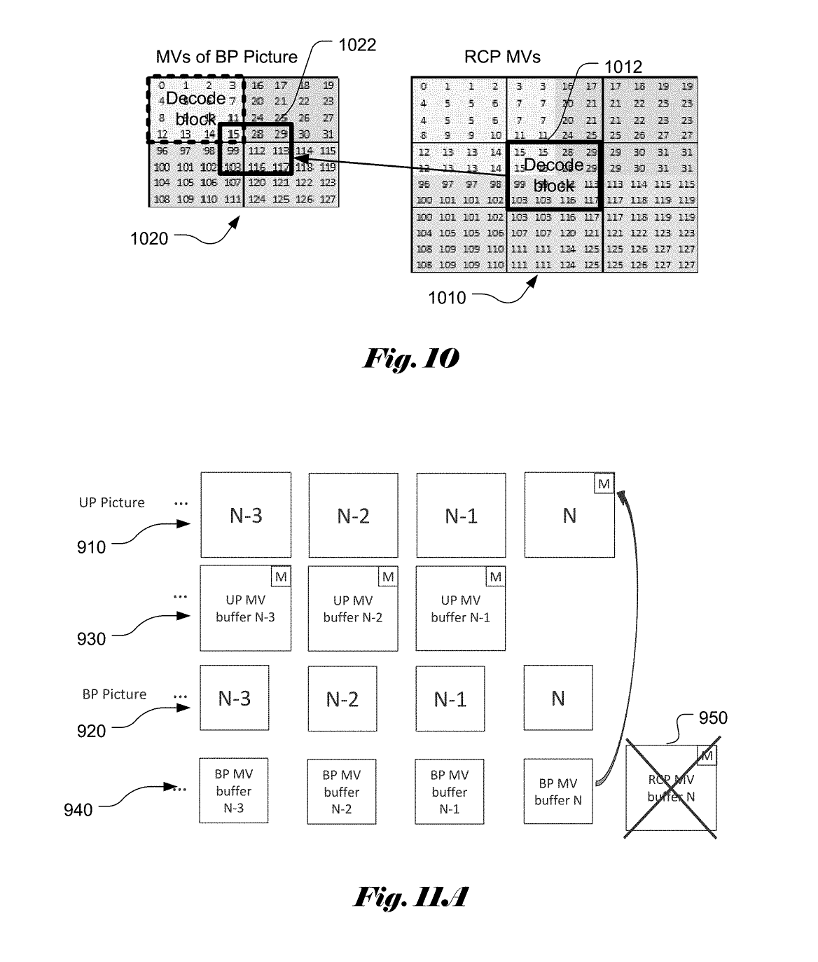

The UP picture is derived from a BP picture or a lower-level UP picture by clipping and resizing as shown in FIG. 3. Therefore, the MVs of BP picture cannot be referenced directly by UP picture due to the offset and resizing ratio between BP and UP. For example, a Decode Block of RCP MVs may be scaled from four Decode_blocks of the MVs of BP picture as shown in FIG. 10. The Decode_Block can be a unit used for video coding or processing such as a macroblock as defined in the MPEG2 and H.264 standards, CTBs (coding tree blocks) as defined in HEVC, SB (super block) as defined in VP9, or LCU (largest coding unit) as defined in AVS2, block as defined in MPEG2, H.264, Coding Unit as defined in HEVC, VP9 and AVS2, Prediction Unit as defined in HEVC, VP9 and AVS2. The collocated MV RC processing off-Line method needs an extra memory space for the RCP MVs scaled from the MVs of BP picture. In FIG. 10, The BP picture is resized to the UP picture using a resizing ratio of 2:3 without any offset. Therefore a BP picture having a width of two blocks and a height of two blocks will be resized to a UP picture having a width of three blocks and a height of three blocks, where each block consists of 4×4 samples. For a current block 1012 in the UP picture 1010, the UP block 1012 is derived using the BP block 1022 in the BP picture 1020. As shown in FIG. 10, the block 1022 is crossing all four blocks of the BP picture 1020. Therefore, the RCP for the UP block 1012 requires information from four MV Decode_blocks of the corresponding BP picture.

FIG. 11A illustrates another perspective of collocated MV handling by the RCP for an on-the-fly method. The collocated MV RC processing on-the-fly method doesn't need an extra memory space for the RCP MVs scaled from the MVs of BP picture because the UP MV processing includes the RC Processing. The system may be based on the same components as these in FIG. 9A except for the RCP MV buffer. As shown in FIG. 11A, the system uses a series of UP pictures 910, BP pictures 920, UP MV buffers 930 and BP MV buffers 940 are indicated. However, RCP MV buffer N 950 is not needed as shown in FIG. 11A. FIG. 11B illustrates an example of MVs associated with BP pictures and UP pictures. However, the RCP MVs are not stored in memory 1110 as shown in FIG. 11B.

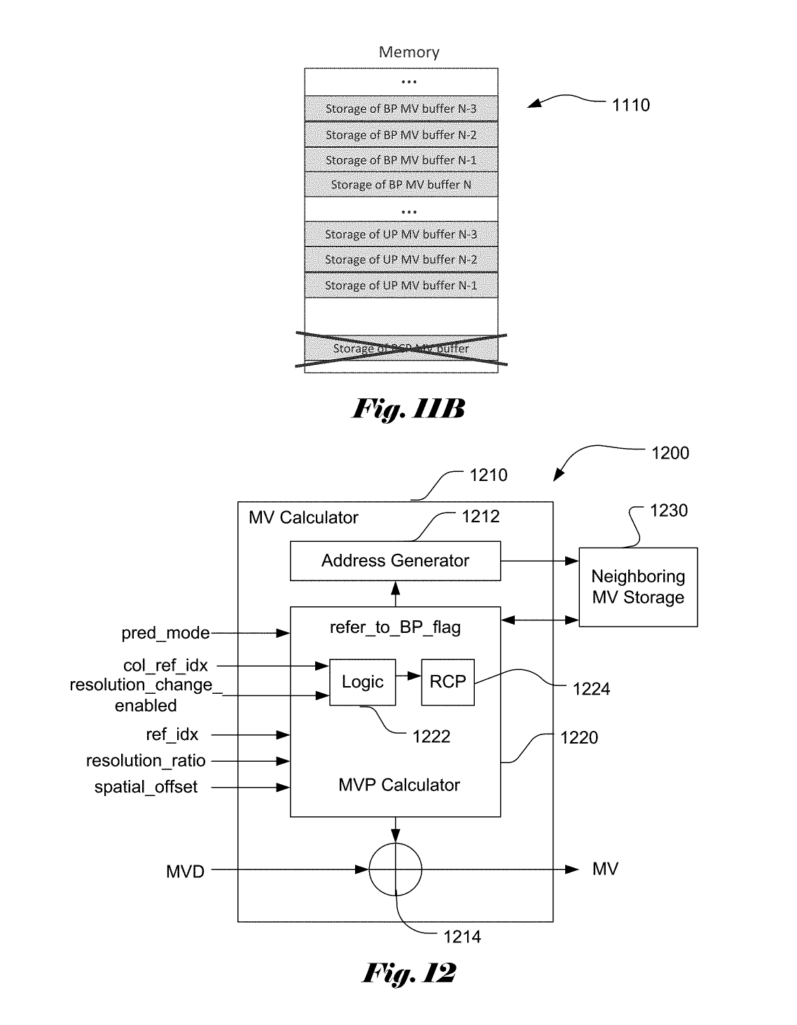

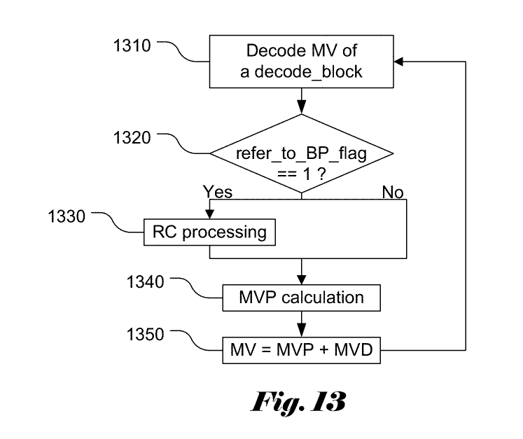

FIG. 12 illustrates an exemplary architecture of RCP MV derivation 1200. For the RCP MV derivation, the input signals comprise:
pred_mode: indicates prediction mode including I, P and B modes.
ref_idx: indicates the index of reference picture for motion compensation.
col_ref_idx: indicates the index of reference picture for collocated MV.
resolution_change_enabled: resolution_change_enabled equal to 1 specifies that BP can be referenced when decoding UP. resolution_change_enabled equal to 0 specifies that BP cannot be referenced when decoding UP.
resolution_ratio: indicate the resolution ratio between BP and UP.
spatial_offset: indicate the spatial offset between BP and UP.
MVD: MV difference for MV calculation.

The output signals comprise:

MV: motion vector for motion compensation.

The Neighboring MV Storage is used for saving neighbor MV data including spatial predictor and temporal predictor. The temporal predictor may be based on the MVs of previous UP picture and the MVs of BP picture. The storage can be register arrays, SRAM, or any other memory which can be quickly accessed.

Address Generator generates the address of Neighboring MV Storage to retrieve the neighbor MV data according to current location. When the MVP calculation unit needs the MVs of the BP picture, address generator needs to use extra information including resolution_ratio and spatial_offset to generate the address of Neighboring MV Storage.

The MVP Calculation unit calculates MVP according to input signals and neighbor MV data.

When the refer_to_BP_flag is equal to 1, the MVP Calculation unit will refer to the RCP MVs scaled from the MVs of BP picture by the RCP.

The architecture for RCP MV derivation comprises an MV calculation unit 1210 and Neighboring MV Storage 1230. The MV calculation unit 1210 comprises address generator 1212, MVP calculation unit 1220 and adder 1214. The address generator 1212 provides the address for accessing the neighboring MVs for the RCP and MVP calculation unit 1220. The MVP calculation unit 1220 generates the MVP, which is added to the MVD using adder 1214 to generate the reconstructed MV. The MVP calculation unit 1220 may comprise a logic unit 1222 to derive refer_to_BP_flag for the RCP 1224 based on col_ref_idx and resolution_change_enabled. When resolution_change_enabled equal to 1 and the reference picture decided by col_ref_idx is BP, the refer_to_BP_flag is set to 1. When refer_to_BP_flag is equal to 1, the MVP calculation unit 1224 will refer to the RCP MVs scaled from the MVs of BP picture by RC processing.

FIG. 13 illustrates an exemplary flowchart of MV derivation according to an embodiment of the present invention. The MV of a decode_block is decoded in step 1310. Whether refer_to_BP_flag is equal to 1 is checked in step 1320. If refer_to_BP_flag is equal to 1, the RC processing is performed in step 1330. Otherwise, the RC processing is skipped. In step 1340, MVP is derived and the derived MVP is combined with MVD to reconstruct the MV in step 1350.

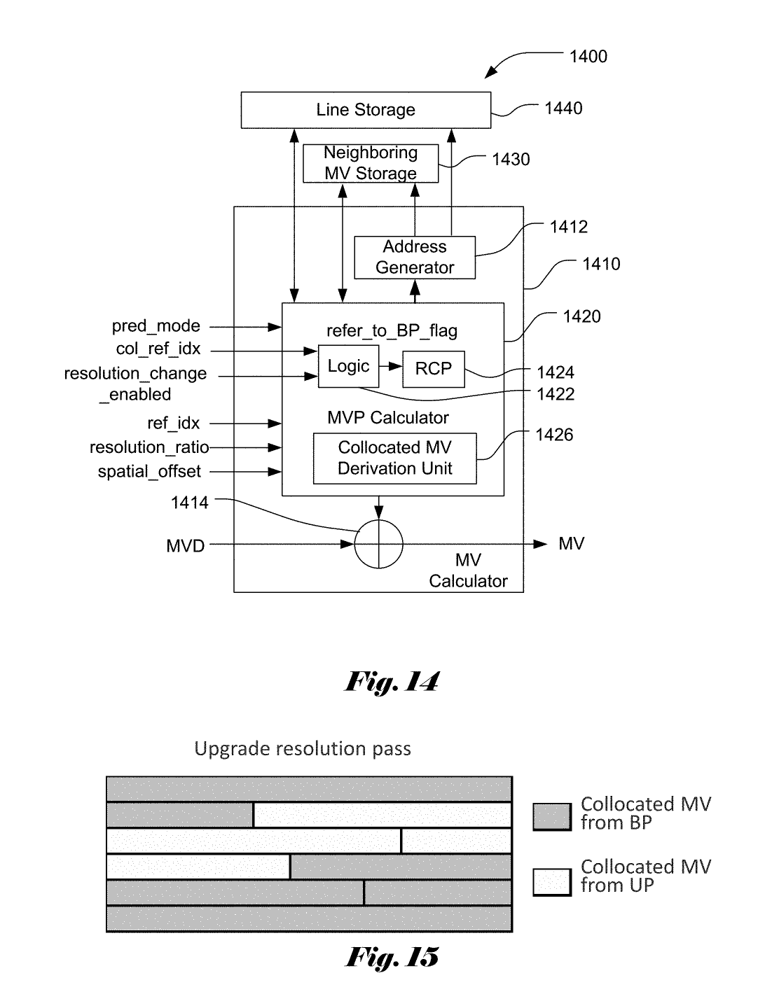

FIG. 14 illustrates another exemplary architecture of RCP MV derivation 1400. For the RCP MV derivation, the input signals and output signal are the same as the system in FIG. 12. The system is similar to the system in FIG. 12. However, the system in FIG. 14 uses additional Line Storage 1440 and a collocated MV derivation unit 1426. The address generator 1412 needs to generate the additional address for the Line Storage 1440 to get neighbor MV data.

The architecture for RCP MV derivation in FIG. 14 comprises an MV calculation unit 1410, Neighboring MV Storage 1430 and Line Storage 1440. The Line Storage 1440 saves at least one Decode_block line of the MVs of BP picture when resolution_change_enabled equal to 1. The Line Storage can be implemented using register arrays, SRAM, or any other memory that can be quickly accessed. The MV calculation unit 1410 comprises address generator 1412, MVP calculation unit 1420 and adder 1414. The address generator 1412 provides the address for accessing the neighboring MVs stored in Line Storage 1440 and Neighboring MV Storage 1430 for the RCP. The MVP calculation unit 1420 generates the MVP, which is added to the MVD using adder 1414 to generate the reconstructed MV. The MVP calculation unit 1420 may comprise a logic unit 1422 to derive refer_to_BP_flag for the RCP 1424 based on col_ref_idx and resolution_change_enabled. The MVP calculation unit 1420 also includes collocated MV derivation unit 1426, which saves the MVs of BP picture from Line Storage 1440 and Neighboring MV Storage 1430 when resolution_change_enabled equal to 1. The MVP calculation unit will get the MVs of BP picture from this unit. When resolution_change_enabled equal to 1 and the reference picture decided by col_ref_idx is BP, the refer_to_BP_flag is set to 1. When refer_to_BP_flag is equal to 1, the MVP calculation unit 1420 will refer to the RCP MVs scaled from the MVs of BP picture by RC processing.

When resolution_change_enabled equal to 1, the Line Storage 1440 and Collocated MV Derivation Unit 1426 should be maintained regardless whether the collocated MV of current Decode_block is from BP or UP. FIG. 15 illustrates an example that the collocated MV of UP picture is from BP or UP when resolution_change_enabled is equal to 1.

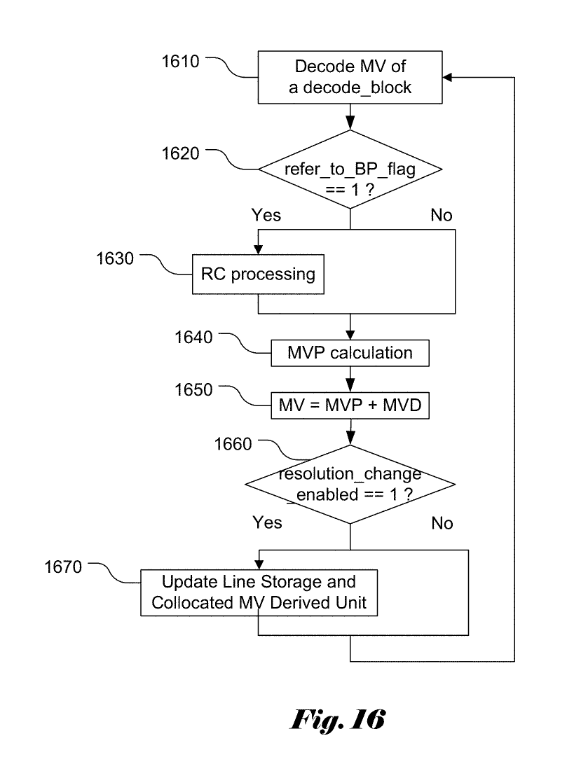

FIG. 16 illustrates an exemplary flowchart of MV derivation according to an embodiment of on-the-fly method. The MV of a decode block is decoded in step 1610. Whether refer_to_BP_flag is equal to 1 is checked in step 1620. If refer_to_BP_flag is equal to 1, the RC processing is performed in step 1630. Otherwise, the RC processing is skipped. In step 1640, MVP is derived and the derived MVP is combined with MVD to reconstruct the MV in step 1650. Whether resolution_chanhe_enabled is equal to 1 is check in step 1660. If resolution_chanhe_enabled is equal to 1, the Line Storage and Collocated MV Derivation Unit are updated in step 1670 and the process goes back to step 1610. If resolution_chanhe_enabled is not equal to 1, the process goes back to step 1610.

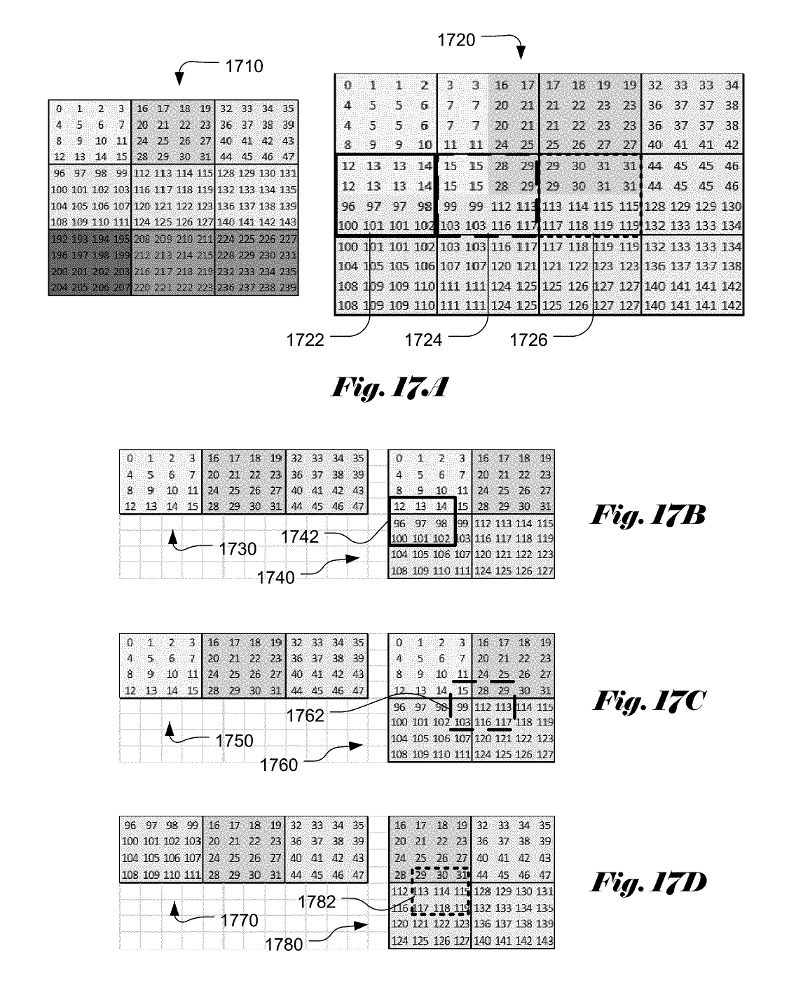

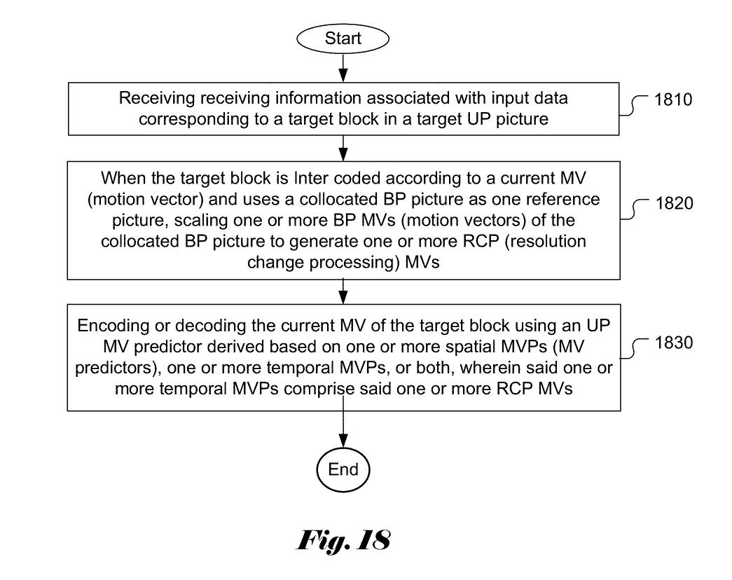

FIGS. 17A-17D illustrate an example of collocated MV RC processing based on the on-the-fly method. In this example, BP picture resolution is 384×192, UP picture resolution is 576×288, resolution ratio is 1.5 (i.e., 2:3) and spatial offset is 0. In FIG. 17A, the upper-left corner blocks for the BP 1710 and 1720 are shown. Each block consists of 4×4 pixels. The upper-left area of the BP picture include two blocks horizontally and two blocks vertically. Since 2:3 resolution is used, the BP area 1710 is mapped to UP area 1720, which consists of three blocks horizontally and three block vertically. In FIG. 17A, the first three blocks (i.e., 1722, 1724 and 1726) in the second row of the UP picture are being processed. When decoding the second row of the UP picture, the Line Storage and Collocated MV Derivation Unit are updated as shown in FIG. 17B through FIG. 17D. In FIG. 17B, the decode_block corresponds to block 1722. The line storage 1730 and the block 1742 being processed in the UP picture area 1740 by the Collocated MV Derivation Unit are shown. The MV Calculation Unit decodes decode_block_1 of UP picture. The Line Storage and Collocated MV Derivation Unit do not need to be updated. In FIG. 17C, the decode_block corresponds to block 1724. The line storage 1750 and the block 1762 being processed in the UP picture area 1760 by the Collocated MV Derivation Unit are shown. The MV Calculation Unit decodes decode_block_2 of UP picture. The Line Storage is updated by Collocated MV derivation unit, and the Collocated MV derivation unit is updated by Line Storage and Neighboring MV Storage. In FIG. 17D, the decode block corresponds to block 1726. The line storage 1770 and the block 1782 being processed in the UP picture area 1780 by the Collocated MV Derivation Unit are shown. The MV Calculation Unit decodes decode_block_3 of UP picture. In the above example, after decodes decode_block_2 is processed and before decodes decode_block_3 is processed, some data movement occurs. First, sub-block for samples 96 through 111 are moved from Collocated MV derivation unit to Line Storage. Then, sub-block for samples 16 through 31 and sub-block for samples 112 through 127 are moved to the left by four sample positions; sub-block for samples 32 through 47 is from Line Storage to Collocated MV derivation unit; and sub-block for samples 128 through 143 are moved from Neighboring MV Storage to Collocated MV derivation unit.

FIG. 18 illustrates an exemplary flowchart of scalable video coding using Inter prediction mode for a video coding system incorporating an embodiment of the present invention, where video data being coded comprise BP (Basic Resolution Pass) pictures and UP (Upgrade Resolution Pass) pictures. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, information associated with input data corresponding to a target block in a target UP picture are received in step 1810. When the target block is Inter coded according to a current MV (motion vector) and uses a collocated BP picture as one reference picture, one or more BP MVs (motion vectors) of the collocated BP picture are scaled to generate one or more RCP (resolution change processing) MVs in step 1820. The current MV of the target block is encoded or decoded using an UP MV predictor derived based on one or more spatial MVPs (MV predictors), one or more temporal MVPs, or both in step 1830, where said one or more temporal MVPs comprise said one or more RCP MVs.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of scalable video coding using Inter prediction mode for a video coding system, wherein video data being coded comprise BP (Basic Resolution Pass) pictures and UP (Upgrade Resolution Pass) pictures, the method comprising:
receiving information associated with input data corresponding to a target block in a target UP picture;
when the target block is Inter coded according to a current MV (motion vector) and uses a collocated BP picture as one reference picture, scaling one or more BP MVs (motion vectors) of the collocated BP picture to generate one or more RCP (resolution change processing) MVs; and
encoding or decoding the current MV of the target block using an UP MV predictor derived based on one or more spatial MVPs (MV predictors), one or more temporal MVPs, or both, wherein said one or more temporal MVPs comprise said one or more RCP MVs.

2. The method of claim 1, wherein the target block in the target UP picture has a same frame time as the collocated BP picture.

3. The method of claim 1, wherein whether the target block uses the collocated BP picture as one reference picture is determined based on prediction mode of the target block, reference picture index of the target block, reference picture index for a collocated MV, resolution change enable flag, resolution ratio of the target UP picture and the collocated BP picture, spatial offset between the target UP picture and the collocated BP picture, or a combination thereof, and wherein the resolution change enable flag specifies whether the collocated BP picture can be referenced when decoding the target UP picture.

4. The method of claim 1, wherein said one or more RCP MVs are derived by scaling said one or more BP MVs of the collocated BP picture according to resolution ratio of the target UP picture and the collocated BP picture and spatial offset between the target UP picture and the collocated BP picture.

5. The method of claim 1, wherein an MVD (MV difference) between the current MV of the target block and the UP MV predictor is signaled at an encoder side or the current MV of the target block is reconstructed from the MVD received and the UP MV predictor.

6. The method of claim 1, wherein said one or more temporal MVPs comprise one or more UP MVPs derived from one or more previous UP pictures.

7. The method of claim 6, wherein UP MVs from said one or more previous UP pictures and BP MVs of the collocated BP picture are stored in neighboring MV storage or a combination of line storage and the neighboring MV storage.

8. The method of claim 7 comprising generating one or more addresses for the neighboring MV storage or the combination of the line storage and the neighboring MV storage according to a current location of the target block to access neighboring MV data for deriving said one or more temporal MVPs.

9. The method of claim 7, wherein the line storage stores at least one block row of BP MVs of the collocated BP picture.

10. The method of claim 7, wherein when a target UP picture uses the collocated BP picture as one reference picture, the line storage is updated.

11. An apparatus scalable video coding using Inter prediction mode for a video coding system, wherein video data being coded comprise BP (Basic Resolution Pass) pictures and UP (Upgrade Resolution Pass) pictures, the apparatus comprising:
an MVP calculation unit configured to:
receive information associated with input data corresponding to a target block in a target UP picture;
when the target block is Inter coded using a current motion vector and uses a collocated BP picture as one reference picture, scale one or more BP MVs (motion vectors) of the collocated BP picture to generate one or more RCP (resolution change processing) MVs; and
an MV prediction unit configured to encode or decode a target MV of the target block using one or more spatial MVPs (MV predictors), one or more temporal MVPs, or both, wherein said one or more temporal MVPs comprise said one or more RCP MVs.

12. The apparatus of claim 11, wherein the target block in the target UP picture has a same frame time as the collocated BP picture.

13. The apparatus of claim 11, wherein the MVP calculation unit is further configured to determine whether the target block uses the collocated BP picture as one reference picture based on prediction mode of the target block, reference picture index of the target block, reference picture index for a collocated MV, resolution change enable flag, resolution ratio of the target UP picture and the collocated BP picture, spatial offset between the target UP picture and the collocated BP picture, or a combination thereof, and wherein the resolution change enable flag specifies whether the collocated BP picture can be referenced when decoding the target UP picture.

14. The apparatus of claim 11, wherein said one or more RCP MVs are derived by scaling said one or more BP MVs of the collocated BP picture according to resolution ratio of the target UP picture and the collocated BP picture and spatial offset between the target UP picture and the collocated BP picture.

15. The apparatus of claim 11, wherein the MV prediction unit derives an MVD (MV difference) between the current MV of the target block and the UP MV predictor at an encoder side or reconstructs the current MV of the target block from the MVD received and the UP MV predictor.

16. The apparatus of claim 11, wherein said one or more temporal MVPs comprise one or more UP MVPs derived from one or more previous UP pictures.

17. The apparatus of claim 16, wherein the apparatus further comprising neighboring MV storage or a combination of line storage and the neighboring MV storage to store UP MVs from said one or more previous UP pictures and BP MVs of the collocated BP picture.

18. The apparatus of claim 17, the apparatus further comprising an address generator configured to generate one or more addresses for the neighboring MV storage or the combination of the line storage and the neighboring MV storage according to a current location of the target block to access neighboring MV data for deriving said one or more temporal MVPs.

19. The apparatus of claim 18, wherein when a target picture uses the collocated BP picture as one reference picture, the MVP calculation unit and the address generator are configured to update the line storage.

20. The apparatus of claim 17, wherein the line storage stores at least one block row of BP MVs of the collocated BP picture.
